(19) United States
(12) Patent Application Publication
(10) Pub. No.: US 2008/0024407 A1
(43) Pub. Date: Jan. 31, 2008

(54) Liquid crystal display device

(75) Inventor: Shuji Yamaguchi, Kawasaki (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KAWASAKI (JP)

(21) Appl. No.: 11/878,687

(22) Filed: Jul. 26, 2007

(30) Foreign Application Priority Data
Jul. 27, 2006 (JP) 2006-204968

(51) Int. Cl. G09G 3/36

(52) U.S. Cl. 345/87

(57) ABSTRACT

A liquid crystal display (LCD) panel includes a pixel array region surrounded by a peripheral edge region. Gate driver TAB members are connected to the edge region. A group of lines for gate drivers which connects the gate driver TAB members is formed in the edge region. A shield layer which covers the group of lines for gate drivers is formed in the edge region.

This application is based upon and claims the benefit of priority from Japanese patent application No. 2006-204968, filed on Jul. 27, 2006, the disclosure of which is incorporated herein in its entirety by reference.

### BACKGROUND OF THE INVENTION

1. Field of the Invention

The present invention relates to a liquid crystal display (LCD) device and in particular, relates to an LCD device with a structure where a group of wiring lines is formed on an LCD panel for connecting gate drivers.

2. Description of the Related Art

Since there are advantages such as a thin shape, a light weight and low power consumption, LCD devices are widely used as a display unit for audio & visual (AV) apparatus or office automation (OA) apparatus. An LCD device has an LCD panel in which a liquid crystal (LC) material is sandwiched between two substrates. Switching elements such as thin film transistors (TFTs) are arranged on one substrate in a matrix. Hereinafter, a substrate having the TFTs is referred to as a TFT substrate. A color filter (CF) layer and a black matrix (BM) layer or the like are formed on the other substrate. Hereinafter, a substrate having the CF layer or the like is referred to a CF substrate. In the LCD device, the director of LC molecules is controlled by an electric field applied between a pair of electrodes formed on the TFT substrate or between a pair of electrodes formed on the TFT substrate and the CF substrate respectively. Such control changes light transmittance to display an image. In order to supply a drive signal to the LCD panel, external connection terminals are provided on an edge region of the LCD panel. Driver circuits such as gate drivers or data drivers are connected to the external connection terminals, respectively. Japanese Patent Application Laid-Open No. 2005-215530 discloses an LCD device in which gate driver IC chips are mounted on a flexible substrate, a data driver IC chip is mounted on another flexible substrate and the flexible substrates are connected to a glass substrate.

In such the LCD device, a printed circuit board or a connecting substrate may be used to electrically connect the gate drivers by electrically connecting adjacent flexible substrates in common. Wiring lines connecting the gate drivers are provided on the connecting substrate.

It is proposed that wiring lines for connecting the gate drivers are incorporated in the LCD panel in order to remove the connecting substrate and thereby reducing the number of parts needed for an LCD device. By adopting such structure, the LCD device can be made thin and its weight can be reduced.

When incorporated in an LCD panel, the wiring lines for gate drivers have to be protected from a noise. When the noise is influential, the gate drivers may malfunction.

### SUMMARY OF THE INVENTION

Accordingly, an exemplary feature of the present invention is to provide the liquid crystal display device which reduces influence from wiring lines acting as noise sources in an LCD device with which a group of wiring lines associated with gate drivers are formed in or on an LCD panel.

The liquid crystal display device according to an exemplary aspect of the present invention includes an LCD panel which includes a pixel array region surrounded by a peripheral edge region. The edge region of the LCD panel is designed to connect plural gate driver tape-automated-bonding (TAB) members and a data driver TAB member. Each of the gate driver TAB members includes a gate driver for driving the LCD panel. A group of wiring lines for gate drivers which connect the gate drivers of the gate driver TAB members is disposed in the edge region of the LCD panel. A shield layer overlapping at least part of the group of lines for the gate drivers is disposed in the edge region of the LCD panel.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The above and other objects, features and advantages of the present invention will become more apparent from the following detailed description when taken in conjunction with the accompanying drawings wherein:

FIG. 1 is a plan view in schematic form depicting a peripheral edge region of an LCD device according to a first exemplary embodiment of the present invention;

FIG. 2 is a cross sectional view along I-I line of the LCD device shown in FIG. 1;

FIG. 3 is a plan view showing a structure of the terminal area of the LCD device according to the first exemplary embodiment of the present invention;

FIG. 4 is a cross sectional view along II-II line of the terminal area shown in FIG. 3;

FIGS. 5A and 5B are an electric flux line distribution map illustrating an advantage of the LCD device according to the first exemplary embodiment of the present invention;

FIG. 6 is a signal waveform diagram illustrating an advantage of the LCD device according to the first exemplary embodiment of the present invention;

FIG. 7A is a cross sectional view along I-I line of FIG. 1, showing the peripheral edge region of the LCD device according to a second exemplary embodiment of the present invention;

FIG. 7B is another cross sectional view of FIG. 1, showing the peripheral edge region of the LCD device according to a second exemplary embodiment of the present invention;

FIG. 8 is a plan view showing the terminal area of the LCD device according to the second exemplary embodiment of the present invention;

FIG. 9 is a cross sectional view along III-III line of the terminal area shown in FIG. 8;

FIG. 10 is a plan view in schematic form depicting a peripheral edge region of an LCD device according to a third exemplary embodiment of the present invention;

FIG. 11 is a cross sectional view along IV-IV line of the LCD device shown in FIG. 10;

FIG. 12 is a plan view showing the terminal area of the LCD device according to the third exemplary embodiment of the present invention;

FIG. 13 is a plan view showing a peripheral edge region of an LCD device according to a related art; and

FIG. 14 is a signal waveform diagram of the LCD device according to the related art.

### DETAILED DESCRIPTION OF THE EXEMPLARY EMBODIMENTS

Preferred embodiments of the present invention will now be described in detail in accordance with the accompanying drawings.

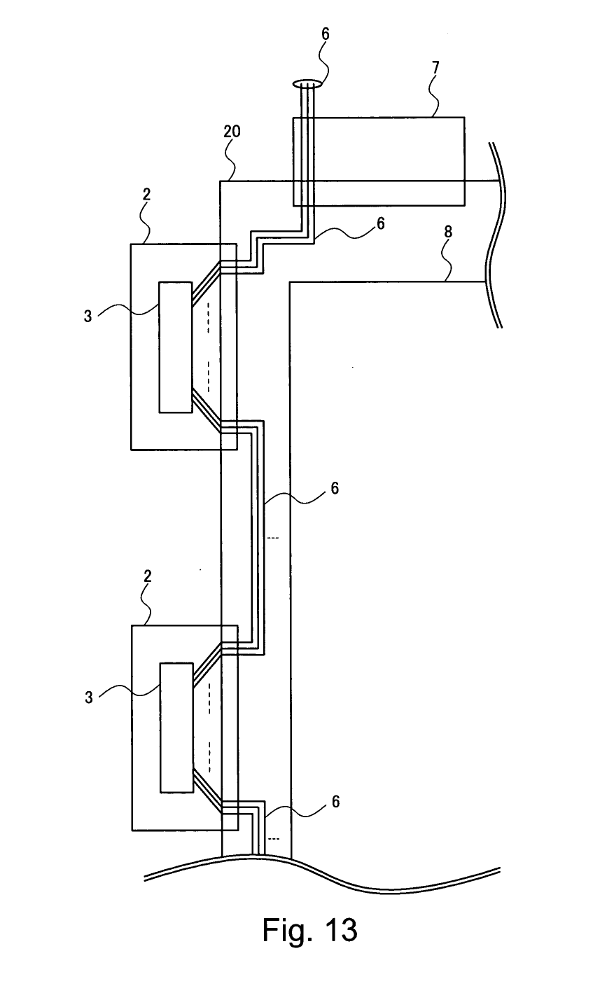

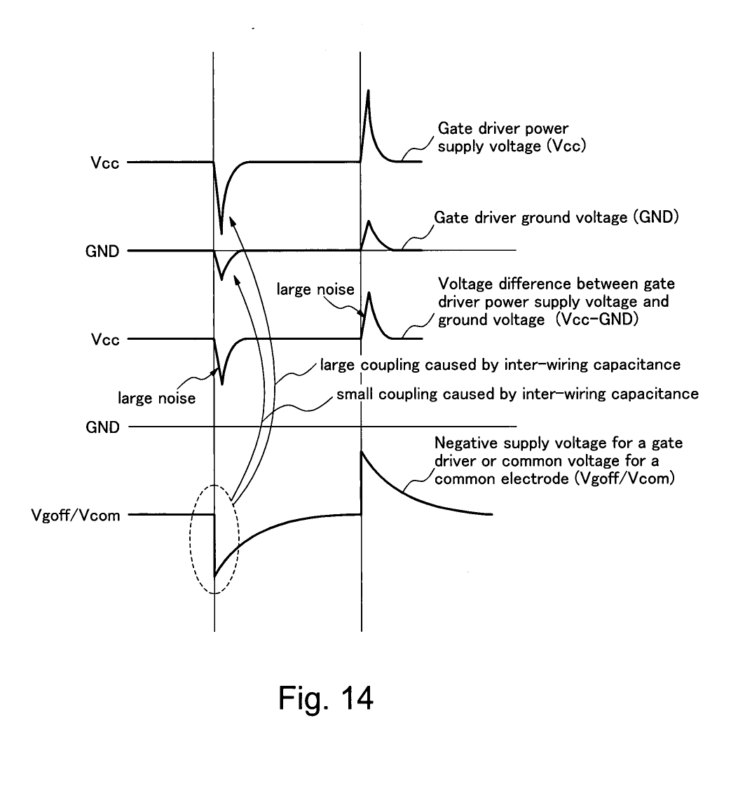

An LCD device which does not include a connecting substrate for connecting gate drivers will be described with reference to drawings. As shown in FIG. 13, an LCD device includes an LCD panel 20 provided with driver TAB members 2 and 7 for driving gate and data electrodes, respectively. The LCD panel 20 includes a liquid crystal layer sandwiched between a pair of substrates thereof. The LCD panel 20 includes a pixel array region 8 surrounded by a peripheral region or an edge region. In the edge region, in order to drive the LCD panel 20, the driver TAB members 2 and 7 are connected to the edge region of the LCD panel 20. Each gate driver TAB member 2 includes a gate driver LSI 3 mounted on a TAB tape. A group of wiring lines 6 for gate drivers is provided on the edge region so as to perform as a interconnecting lines such as a power supply line and signal lines which are necessary for all the gate driver LSIs 3. By using such interconnecting lines 6, a printed circuit board or a connecting substrate can be eliminated, and both of thickness and weight of an LCD device can be reduced.

In such a structure, a wiring line may couple with another wiring line serving as a noise source in the group of lines 6 due to capacitance among the lines 6. Further, noise from the above-stated noise source line is superposed on a signal in the coupled wiring line above-described. As a result, a gate driver may malfunction.

When wiring line length of the lines 6 becomes long, influence on other wiring lines due to the noise from the noise source line may become great. In a large LCD panel 20, the wiring line length of the group of lines 6 may be several tens of centimeters. The group of lines 6 is formed of the same material as a gate line and a drain line used in the LCD panel 20. On the other hand, the connecting substrate generally utilizes copper as wiring lines. Resistance of the group of lines 6 is larger than that of the wiring lines in the connecting substrate. Further, in the group of lines 6, space between the wiring lines is small. Accordingly, a parasitic capacitance between the wiring lines becomes large, and influence of noise also becomes large.

Wiring lines for a negative power supply and a common electrode of a gate driver may become a noise source in the group of wiring lines. Because an electric current flows into the two wiring lines via a parasitic capacitance of the whole LCD panel, electric potential of the wiring lines fluctuates within several volts according to a displayed image. When negative power supply voltage (Vgoff) and common voltage for a common electrode (V_{COM}) of the gate driver change, power supply voltage (V_{CC}) of the gate driver fluctuates from a predetermined level of power supply voltage. When the Vgoff and the V_{COM} for the common electrode of the gate driver change, ground voltage (GND) of the gate driver fluctuates from ground potential. FIG. 14 shows states of wiring lines in that time, specifically shows states of GND and logic V_{CC} of the gate driver. The gate driver receives the V_{CC} and the GND of a gate driver, and is operated by the difference voltage between the V_{CC} and the GND. As a result, noise as shown in FIG. 14 is superposed on the difference voltage, that is, V_{CC}−GND. By a level of the noise, the gate driver may malfunction due to fluctuation of a threshold level or the like of logic input. Such noise superposition may occur between the noise source line and all wiring lines which are arranged along the noise source line. Here, positional arrangements between each of the above-mentioned two wiring lines and the noise source line are not necessarily equal to each other, because the arrangements are depended on driver's terminal arrangement and a wiring layout on the LCD panel. Because parasitic capacitances between each of the two wiring lines and the noise source line are also different respectively, amount of noise may also be different respectively as shown in FIG. 14.

Accordingly, in the exemplary embodiment of the present invention, a shield layer is disposed in an upper side, a lower side or both sides of the group of lines for gate drivers. The shield layer reduces a capacitance between wiring lines which directly causes the noise. As a result, superposition of noise on other wiring lines is reduced. The shield layer can be formed simultaneously with a gate line, a drain line or a pixel electrode of a TFT by using the same conductive material. When one or more terminals to be connected outside the panel are formed by a usual panel process, the noise reduction structure can be realized at low cost.

An LCD device in a first exemplary embodiment of the present invention will be described in detail with reference to drawings.

An LCD panel in an LCD device includes a TFT substrate in which switching elements such as thin film transistors are arranged in matrix and a CF substrate in which a color filter layer and a black matrix layer or the like are formed. An alignment film to which orientation processing (i.e. rubbing processing) is performed is formed on facing surfaces of the substrates. Insulating spacers, such as polymer beads or silica beads, having a predetermined shape are dispersed between the two substrates to form a predetermined cell gap therebetween. When alignment direction of LC molecules sealed in the gap is controlled by an electric field applied with electrodes formed in or on at least one substrate, an image is displayed on the LCD panel.

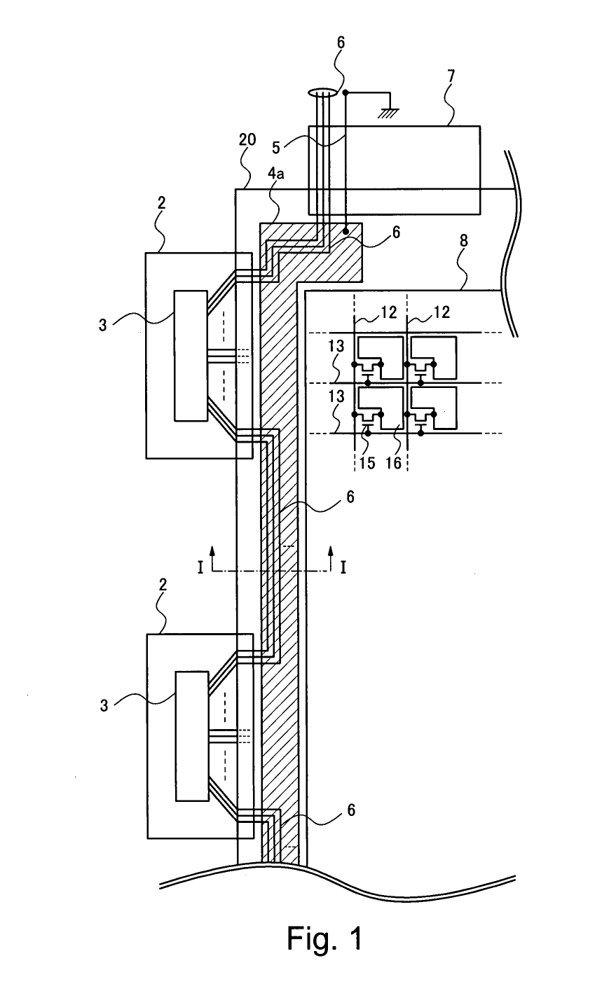

As shown in FIG. 1, the LCD device of the exemplary embodiment includes an LCD panel 20, plural gate driver TAB members 2 and plural data driver TAB members 7. The LCD panel 20 includes a pixel array region 8 in a central portion of the panel and a peripheral edge region around the central portion. The gate driver TAB members 2 and the data driver TAB members 7 are connected to drive the LCD panel 20 in the edge region. Each of the gate driver TAB members 2 includes a TAB tape and a gate driver LSI 3 mounted thereon. A group of lines 6 is arranged in the edge region of the LCD panel 20. The group of lines 6 for gate drivers is a group of lines of a signal and a power supply required to the gate drivers LSI 3 in the gate driver TAB members 2. A signal required to the gate driver LSI 3 is transmitted via the group of lines 6. Plural gate lines 13 and plural drain lines 12 are arranged in the pixel array region 8 and arranged in a direction substantially orthogonal to each other. Pixel electrodes 16 are arranged in areas surrounded with the lines 13 and 12 respectively. Switching elements such as thin film transistors (TFTs) 15 are arranged in matrix between the pixel electrodes 16 and the drain lines 12. A source or a drain electrode of the TFT 15 is connected to the pixel electrode 16 and the drain line 12. A gate electrode of the TFT 15 is connected to the gate line 13.

The group of lines 6 for gate drivers is arranged in the edge region of the LCD panel 20. The group of lines 6 connects the plural gate driver TAB members 2. A group of lines 6 for gate drivers located at corner portion of the LCD panel 20 connects the gate driver TAB member 2 and the data driver TAB member 7.

In the exemplary embodiment, a shield layer 4a which overlaps the group of lines 6 for gate driver is provided on the LCD panel 20. The shield layer 4a is described in detail below.

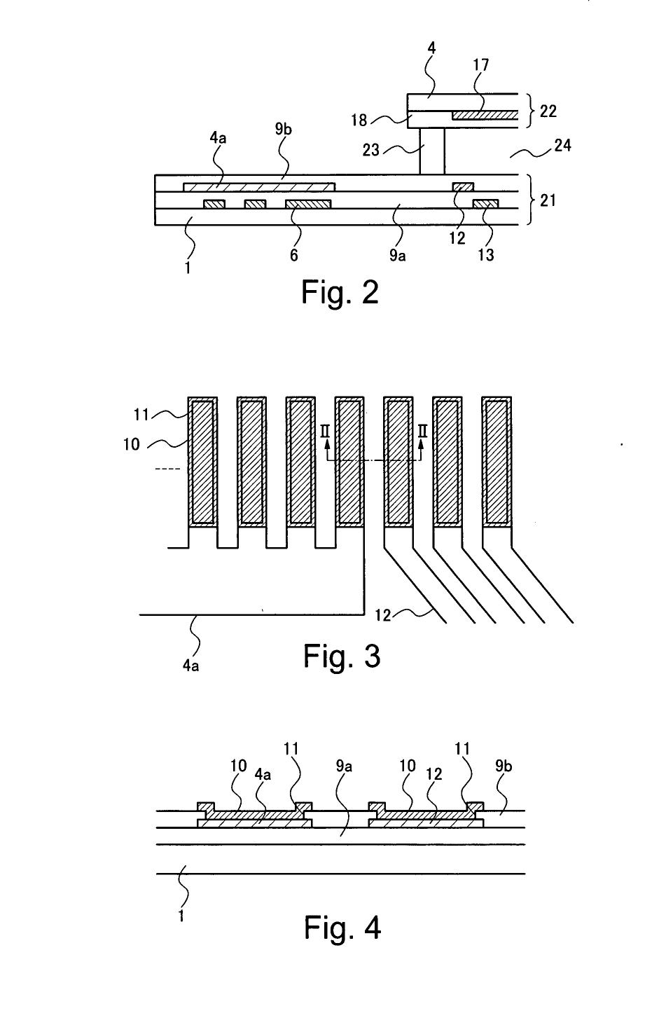

The LCD panel 20 is a panel in which an LC layer is sandwiched between two substrates. As shown in FIG. 2, an LC layer 24 is sandwiched between a TFT substrate 21 as one substrate and a CF substrate 22 as the other substrate. A sealing member 23 seals the LC layer 24 between the two substrates.

As shown in FIGS. 1 and 2, the TFT substrate 21 includes gate lines 13 and gate electrodes of the TFTs 15 which are formed on a transparent insulating substrate such as a glass substrate 1. A semiconductor layer, source and drain electrodes and a drain line 12 of the TFT 15 are formed via an insulating layer 9a like a gate insulation film in the TFT substrate 21. The pixel electrode 16 connected to one electrode of a source or a drain electrode via an insulating layer 9b like a passivation film in the TFT substrate 21.

The CF substrate 22 includes a counter electrode 17 which are formed on a transparent insulating substrate such as a glass substrate 1. The counter electrode 17 opposing to the plural pixel electrodes 16 in the TFT substrate 21 is formed on the glass substrate 1. A color filter layer and a black matrix layer are further formed on the CF substrate 22. An insulating layer 18 is formed to cover the counter electrode 17.

Connection terminals which are connected to the gate line and the drain line 12 are arranged in the edge region in the TFT substrate 21 as shown in FIGS. 3 and 4. The gate driver TAB member 2 and the data driver TAB member 7 are connected with the connection terminals by a pressure bonding process. The data driver TAB member 7 includes the data driver LSI mounted on a TAB tape (not shown in FIG. 1).

A group of lines (group of lines 6 for gate drivers) of a signal and a power supply required to the gate driver 3 of the gate driver TAB member 2 is wired on the glass substrate 1 through the data driver TAB member 7. The group of lines 6 for these gate drivers is formed in a gate line layer of a TFT on the glass substrate 1 of the LCD panel 20.

The gate driver TAB members 2 are connected by the group of lines 6 arranged in parallel on the LCD panel 20. The group of lines 6 is covered with the insulating layer 9a as shown in FIG. 2. A shield layer 4a overlaps the group of lines 6 via the insulating layer 9a. The shield layer 4a is formed in the same layer as a layer in which the drain line 12 of the TFT 15 is formed. The shield layer 4a is covered by the insulating layer 9b.

The contact hole 11 which penetrates the insulating film 9b and connects the connection terminal 10 to the shield layer 4a is formed. The shield layer 4a is extended to one side of the LCD panel 20 to connect to plural external connection terminals 10 via a contact hole 11 as shown in FIGS. 3 and 4. The drain line 12 is also extended to the side of the LCD panel 20 to connect to plural external connection terminals 10 via a contact hole 11 as shown in FIGS. 3 and 4. The plural external connection terminals 10 are arranged at one side of the LCD panel 20 together with plural external connection terminals 10 to which the data driver TAB member 7 is pressure-bonded. As shown in FIG. 4, the shield layer 4a is formed on the insulating film 9a on the glass substrate 1 on which the drain line 12 is formed. The shield layer 4a and the drain line 12 are formed in the same layer on the insulating film 9a. A connection of the shield layer 4a and the data driver TAB member 7 is performed by the same structure as a structure for extracting the drain line 12 on the glass substrate 1. Specifically, as shown in FIG. 2, the shield layer 4a is formed in a layer in which the drain line 12 is formed over the glass substrate 1. Therefore, a terminal for pressure bonding which connects to the shield layer 4a and the data driver TAB member 7 is formed simultaneously in a process for forming the terminals for pressure bonding for connecting the drain line 12 and the data driver TAB member 7.

In FIG. 2, the shield layer 4a is arranged so that all the wiring lines in the group of lines 6 for gate drivers may be overlapped. That is, all the wiring lines in the group of lines 6 are covered with the shield layer 4a. In other word, the shield layer 4a overlaps all the wiring lines in the group of lines 6. However, the shield layer 4a may be arranged so that a part of wiring lines in the group of lines 6 is overlapped. That is, the shield layer 4a may be arranged so that a part of wiring lines in the group of lines 6 may be overlapped selectively. For example, the same advantage as that of above mentioned configuration is obtained, even when only negative power supply line and a panel common electrode line which are main noise sources of a gate driver are covered. In FIG. 1, all areas of the group of lines 6 for gate drivers on the LCD panel 20 are covered with the shield layer 4a. A part of the area of the group of lines 6 may be covered selectively.

The shield layer 4a is connected to an outside of the LCD panel 20, for example, to a signal processing substrate via the data driver TAB member 7 as shown in FIG. 1. Because the shield layer 4a functions as an electrostatic shield, it is desirable for the shield layer 4a to connect with a power supply line with low impedance. In an ordinary LCD device, when connecting with a ground potential (GND) line of a signal processing substrate, the shield layer 4a works best.

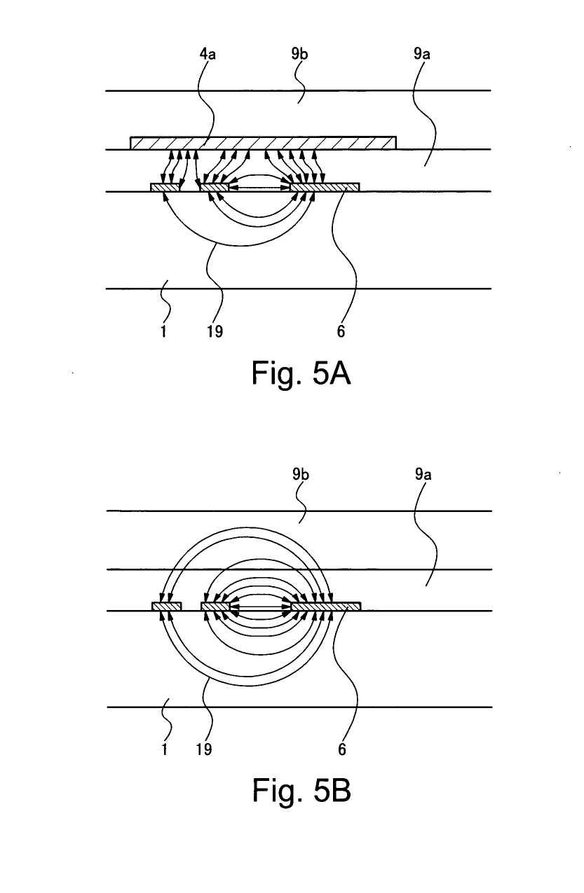

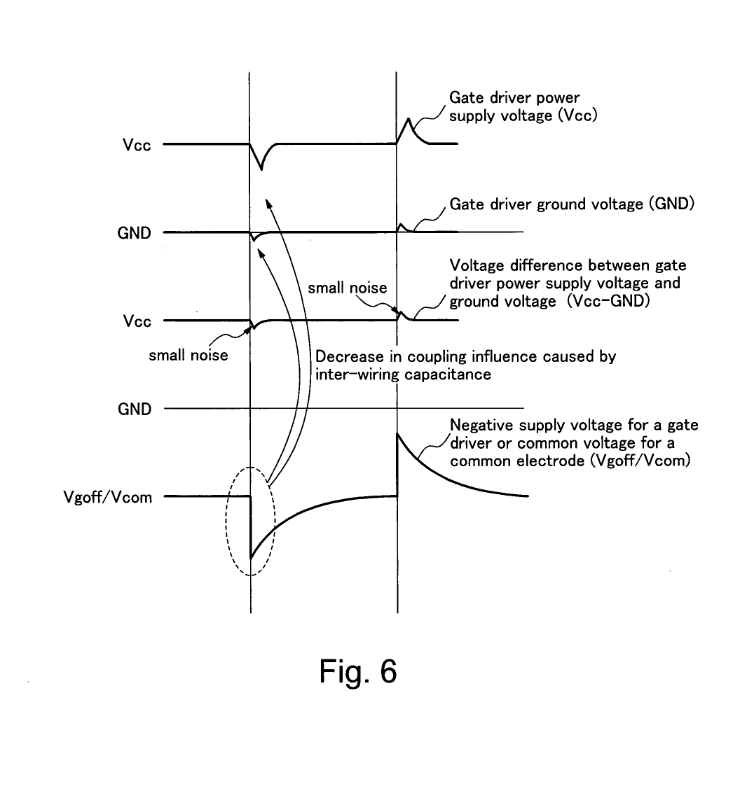

Thus, the shield layer 4a which covers the group of lines 6 for gate drivers reduces parasitic capacitance which occurs between gate lines which are arranged in parallel thereto. FIG. 5A shows a configuration of the exemplary embodiment including the shield layer 4a, and FIG. 5B shows a configuration of a related art without the shield layer 4a. In case of the related art, as shown in FIG. 5B, a large number of electric flux lines 19 from a wiring line in the group of lines 6 spread on the other wiring lines in the group of lines 6. Therefore, the other wiring lines are greatly influenced from the wiring line serving as a noise source. In contrast, in case of the exemplary embodiment, as shown in FIG. 5A, a part of the electric flux line 19 from a wiring line in the group of lines 6 spread on the shield layer 4a, and the rest of the electric flux line 19 spread on the other wiring lines. As shown in FIG. 5A, when the shield layer 4a is formed in an upper layer of the group of lines 6 for gate drivers, the electric flux line 19 which exists between the wiring lines of the group of lines 6 is absorbed by the shield layer 4a. In proportional to an absorbed electric flux line 19, a parasitic capacitance between wiring lines decreases. As a result, as shown in FIG. 6, noise superposed on the driver power supply voltage (the gate driver power supply voltage (V_{CC})—ground voltage (GND)) can be reduced. Further, the present invention becomes advantageous as a distance between the shield layer 4a and the group of lines 6 for gate drivers becomes short.

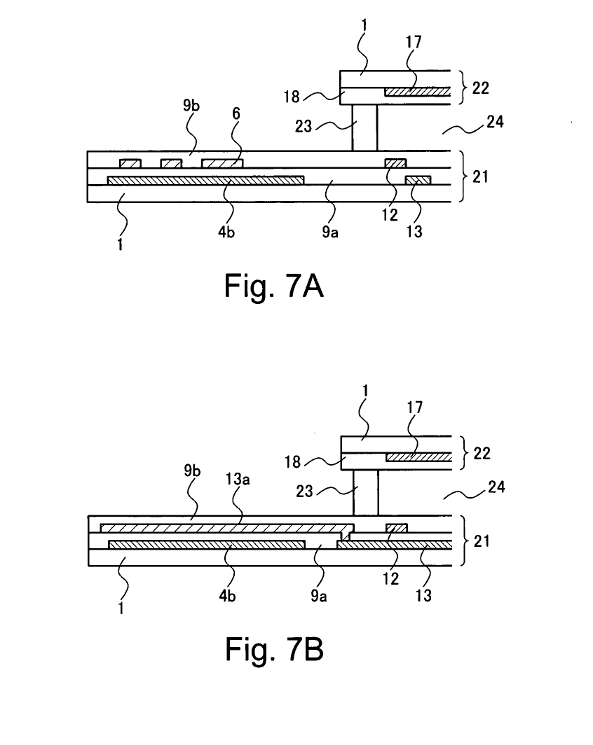

Next, an LCD device according to a second exemplary embodiment of the present invention will be described with reference to FIGS. 7A, 7B, 8 and 9. In the first exemplary embodiment, by forming the shield layer 4a in the same layer as the layer where the drain line 12 is formed, the structure that the shield layer 4a covered the upper part of the group of lines 6 for gate drivers is obtained. In the exemplary embodiment, as shown in FIG. 7A, a shield layer 4b is formed in a layer in which a gate line 13 is formed, and the shield layer 4b covers a lower part of a group of lines 6 for gate drivers. In the case, the shield layer 4b is formed in a layer in which the gate line 13 is formed on the glass substrate 1. The gate line 13 is reconnected to a gate line 13a formed in a layer in which a drain line is formed at the predetermined place of the edge region as shown in FIG. 7B. The gate line 13a crosses over the shield layer 4b without short-circuiting. Conversion between gate and drain wiring layers for crossover of plural wiring lines arranged in a crossing direction is called G-D conversion. By the G-D conversion, the structure of FIG. 7A can be made easily.

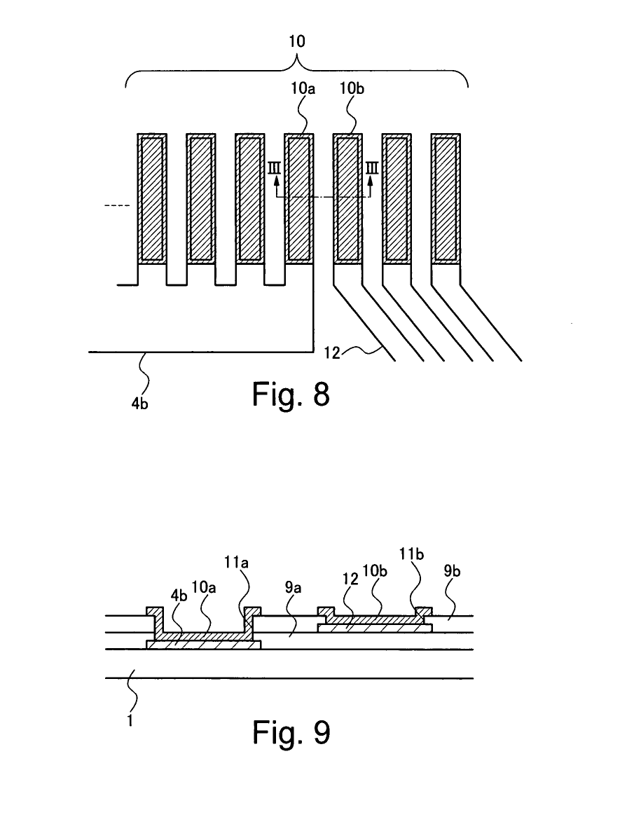

FIGS. 8 and 9 show connection between the shield layer 4b and the data driver TAB member 7. The shield layer 4b is extended to one side of the LCD panel 20 and is connected to external connection terminals 10a as shown in FIG. 8. The external connection terminals 10a are arranged in one side of the LCD panel 20 together with external connection terminals 10b. A drain line 12 is connected to the external connection terminals 10b to which a data driver TAB member 7 is pressure bonded. As shown in FIG. 9, a shield layer 4b is formed on the glass substrate 1. As shown in FIG. 7A, the shield layer 4b is formed on the glass substrate 1 on which the gate line 13 is formed. In other word, the shield layer 4b is formed in a layer where the gate line 13 is formed. A contact hole 11a which penetrates insulating films 9a and 9b on the shield layer 4b and connects the connection terminal 10a to the shield layer 4b is formed. And a contact hole 11a which penetrates insulating film 9b and connects the connection terminal 10b to the drain line 12 is formed. The shield layer 4b and the drain line 12 are connected with an external connection terminal 10a and 10b respectively via the contact holes. In a process of forming a terminal for pressure bonding to connect the drain line 12 and the data driver TAB member 7, a terminal for pressure bonding for connecting the shield layer 4b and the data driver TAB member 7 is formed.

Thus, a positional arrangement between the shield layer 4b and the group of lines 6 for gate drivers in the embodiment becomes reverse to a case of the first exemplary embodiment. However, the electric flux line which exists between wiring lines is absorbed by the shield layer 4b, and the parasitic capacitance between wiring lines decreases in proportion to the absorbed electric flux line. As a result, noise superposed on the driver power supply voltage (the gate driver power supply voltage (V_{CC})—the ground voltage (GND)) can be reduced. The noise reduction structure of the exemplary embodiment can be realized without changing an existing panel process. That is, when a mask pattern for forming the shield layer simultaneously with the gate line and a drain line in a lithographic process is used, the noise reduction structure can be made without using additional masks.

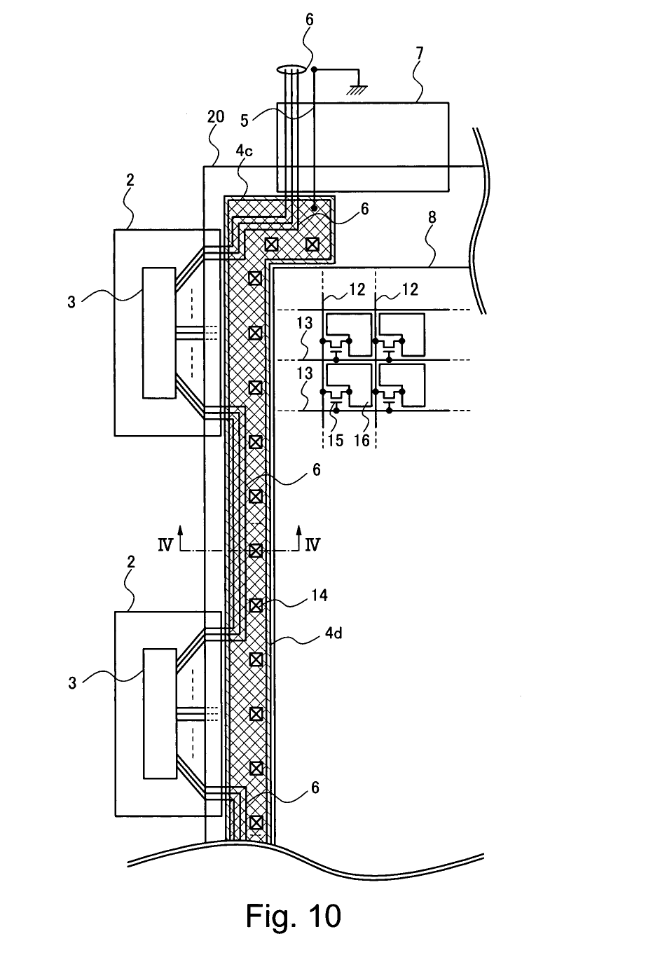

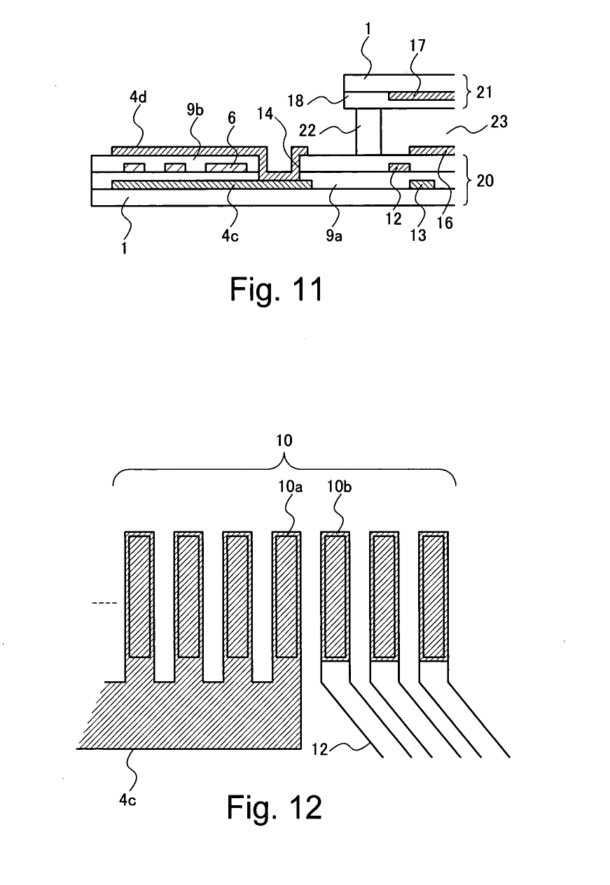

Next, an LCD device according to a third exemplary embodiment of the present invention will be described with reference to FIGS. 10 to 12. In the first exemplary embodiment, the upper part of the group of lines 6 for gate drivers formed in the same layer where the gate line 13 is formed is covered with the shield layer 4a formed in the same layer where the drain line 12 is formed. In the second exemplary embodiment, the lower part of the group of lines 6 for gate drivers formed in the same layer as a layer where the drain line 12 is formed is covered with the shield layer 4b formed in the same layer where the gate line 13 is formed. In the exemplary embodiment, as shown in FIGS. 10 and 11, a group of lines 6 for gate drivers formed in a layer where a drain line 12 is formed is sandwiched between the first shield layer 4c and the second shield layer 4d. The first shield layer 4c and the second shield layer 4d are connected through a contact hole 14 located at the edge region of the LCD panel 20. The first shield layer 4c is formed in a layer where the gate line 13 is formed. The second shield layer 4d is formed in a layer where a transparent electrode layer of a pixel electrode 16 is formed.

In FIG. 10, the contact holes 14 are arranged only in one side of the group of lines 6 for gate drivers. The contact hole 14 may be formed in a long and narrow shape along the group of lines 6 for gate drivers. The contact holes 14 may be formed on both sides of the group of lines 6 for gate drivers. Due to such configuration, connection resistance between the first shield layer 4c and the second shield layer 4d can be lowered. In FIGS. 10 and 11, the first shield layer 4c is slightly larger than the second shield layer 4d. The first shield layer 4c may be approximately equal size to the second shield layer 4d. Further the first shield layer 4c may be a little smaller than the second shield layer 4d. One shield layer may be formed so as to cover all the line groups 6 for gate drivers, and the other shield layer may be formed so as to cover a part of the line groups 6 for gate drivers.

FIG. 12 shows an example of connection structure between the first shield layer 4c and the data driver TAB member 7. The first shield layer 4c extends to one side of an LCD panel 20 to connect to plural external connection terminals 10a as shown in FIG. 12. In one side of the LCD panel 20, the plural external connection terminals 10a are arranged together with plural external connection terminals 10b to which the data driver TAB member 7 is pressure bonded. A drain line 12 connects to the plural external connection terminals 10b to which the data driver TAB member 7 is pressure bonded. As shown in FIG. 11, the first shield layer 4c is formed on the glass substrate 1. As shown in FIG. 11, the first shield layer 4c is formed on the glass substrate 1 on which a gate line 13 is formed. That is, the first shield layer 4c is formed in a layer where the gate line 13 is formed. Contact holes which penetrate insulating films 9a and 9b on the shield layer 4c are formed on the first shield layer 4c. Contact holes which penetrate an insulating film 9b are formed on drain lines 12. An external connection terminal 10b and the drain line 12 are connected via the contact holes. The first shield layer 4c is connected with the second shield layer 4d via contact holes 14. In a process of forming a terminal for pressure bonding for connecting the drain line 12 and the data driver TAB member 7, a terminal for pressure bonding for connecting the shield layer 4c and the data driver TAB member 7 is formed.

In the exemplary embodiment, the group of lines 6 for gate drivers is sandwiched between the first shield layer 4c and the second shield layer 4d which are connected to each other. Because electric flux lines which existed between wiring lines are absorbed in the first shield layer 4c or the second shield layer 4d, parasitic capacitance between wiring lines decreases in proportion to absorbed electric flux lines. As a result, noise superposed on the driver power supply voltage (the gate driver power supply (V_{CC})—the ground voltage (GND)) can be reduced more compared with the first and the second exemplary embodiment. The noise reduction structure of the exemplary embodiment can be realized without changing the existing panel process like the first and the second exemplary embodiment. That is, when using a mask pattern for forming the second shield layer simultaneously with a pixel electrode in the lithographic process, the noise reduction structure can be realized without increasing masks.

An LCD device according to a fourth exemplary embodiment of the present invention includes an LCD panel, plural gate driver TAB members having a gate driver and a data driver TAB member having a data driver. A group of lines for connecting the plural gate driver TAB members are formed in an edge region of one substrate of an LCD panel. A shield layer is formed in an upper part of the group of lines. The shield layer overlaps a part of or all the group of lines in a normal direction to the substrate. The group of lines is formed in a layer where a gate line is formed. The shield layer is also formed in a layer where a drain line is formed.

An LCD device according to a fifth exemplary embodiment of the present invention includes an LCD panel, plural gate driver TAB members each having a gate driver and a data driver TAB member having a data driver. A group of lines for connecting the plural gate driver TAB members are formed in an edge region of one substrate of an LCD panel. A shield layer is formed in a lower part of the group of lines. The shield layer overlaps a part of or all the group of lines in a normal direction to the substrate. By G-D conversion for a gate line, the group of lines is formed in a layer where a drain line is formed. The shield layer is also formed in a layer where the gate line is formed.

An LCD device according to a sixth exemplary embodiment of the present invention includes an LCD panel, plural gate driver TAB members each having a gate driver and a data driver TAB member having a data driver. A group of lines for connecting the plural gate driver TAB members are formed in an edge region of one substrate of an LCD panel. A first and a second shield layers are formed in a lower part and an upper part of the group of lines respectively. The first and a second shield layers overlap a part of or all the group of lines in a normal direction to the substrate. The first shield layer and the second shield layer are connected mutually via a contact hole. By G-D conversion for a gate line, the group of lines is formed in a layer where a drain line is formed. The first shield layer is formed in a layer where the gate line is formed. The second shield layer is formed in a layer where a pixel electrode is formed.

In an LCD device according to a seventh exemplary embodiment of the present invention, the group of lines includes a negative power supply wiring or a common electrode wiring of a gate driver.

An LCD device according to an eighth exemplary embodiment of the present invention, the shield layer or the first shield layer and the second shield layer may be connected to ground potential GND of an external substrate via the data driver TAB member.

According to the LCD device according to the exemplary embodiments of the present invention, influence of noise from wiring such as a negative voltage supply wiring and a common electrode wiring which act a noise source can be reduced. As a result, a malfunction of a gate driver can be prevented effectively.

According to the LCD devices according to the exemplary embodiments mentioned above of the present invention, following advantages are obtained. As the first advantage, influence of coupling noise by parasitic capacitance between wiring lines of an LCD panel which occurs in an only LCD device without a gate driver connecting substrate can be reduced. Therefore, malfunction of a gate driver can be prevented effectively. It is because a shield layer is formed in an upper layer, a lower layer or both of wiring which becomes a noise source such as a negative supply wiring or a common electrode wiring of a gate driver formed in an edge region of the LCD panel. That is, capacitance between the wiring acting as noise source and other wiring is reduced and the superposition of noise to the other wiring, specifically to the wiring for gate drivers, is decreased.

As the second advantage, the above-mentioned noise reduction structure can be realized in low cost. It is because the shield layer can be formed simultaneously with a gate line, a drain line or a pixel electrode of a TFT. It is also because it is possible to form terminals to connect outside of the LCD panel by a usual panel process. Therefore, an additional processing or a new process development becomes unnecessary.

Although a preferred exemplary embodiment has been described above, various change and application are possible for the present invention. In each above-mentioned embodiment, applications to the LCD panel having an inversely staggered TFT, that is, the bottom gate type is explained. That is, an LCD panel equipped with a TFT of the structure that a gate electrode is formed underside, and a source and drain electrode is arranged in the upper side via semiconductor layer has been explained. The present invention can also be applied to an LCD panel having a forward staggered TFT and a top gate type TFT. That is, the present invention can also be applied to an LCD panel having a TFT of the structure that arranged gate electrode in the upper side of the semiconductor layer and arranged a source drain electrode in the underside.

In each above-mentioned embodiment, although the present invention is explained on the application to an LCD device, the present invention is not limited to the above-mentioned embodiment, and can be applied to other display device having an active matrix substrate in which switching elements such as TFTs, for example an organic electroluminescence (OLED) display device.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A liquid crystal display device, comprising:
a liquid crystal display panel including a pixel array region surrounded by a peripheral edge region, the edge region being designed to connect to plural gate driver TAB members and a data driver TAB member;
wherein each of the plural gate driver TAB members includes a gate driver to drive the liquid crystal display panel,
wherein a group of lines for gate drivers is disposed in the edge region of the liquid crystal display panel for connecting the gate drivers, and
wherein a shield layer overlapping at least a part of the group of lines for the gate drivers is disposed in the edge region of the liquid crystal display panel.

2. The liquid crystal display device according to claim 1,
wherein the shield layer is formed in an upper part of the group of lines for gate drivers, the shield layer overlapping the group of lines for gate drivers in a normal direction to the liquid crystal display panel.

3. The liquid crystal display device according to claim 1,
wherein the shield layer is formed in a lower part of the group of lines for gate drivers, the shield layer overlapping the group of lines for gate drivers in a normal direction to the liquid crystal display panel.

4. The liquid crystal display device according to claim 1,
wherein the shield layer includes a first and a second shield layer, the first and second shield layer being formed respectively in lower and upper parts of the group of lines for gate drivers, the first and second shield layer overlapping the group of lines for gate drivers in a normal direction to the liquid crystal display panel.

5. The liquid crystal display device according to claim 4,
wherein the first shield layer and the second shield layer are electrically connected in the edge region of the liquid crystal display panel.

6. The liquid crystal display device according to claim 5,
wherein the first shield layer and the second shield layer are electrically connected at plural positions in the edge region of the liquid crystal display panel.

7. The liquid crystal display device according to claim 2,
wherein the pixel array region includes plural gate lines and plural drain lines intersecting each other, plural pixel electrodes arranged near each of intersections of the gate lines and the drain lines, and plural switching elements arranged near each of the plural pixel electrodes, and
wherein the group of lines for gate drivers is formed in a layer where the plural gate lines are formed and the shield layer is formed in a layer where the plural drain lines are formed.

8. The liquid crystal display device according to claim 3,
wherein the pixel array region includes plural gate lines and plural drain lines intersecting each other, plural pixel electrodes arranged near each of intersections of the gate lines and the drain lines, and plural switching elements arranged near each of the plural pixel electrodes, and
wherein the group of lines for gate drivers is formed in a layer where the plural drain lines are formed and the shield layer is formed in a layer where the plural gate lines is formed.

9. The liquid crystal display device according to claim 8,
wherein using G-D conversion of gate lines, the group of lines for gate drivers is formed in a layer where the plural drain lines are formed in the edge region of the liquid crystal display panel.

10. The liquid crystal display device according to claim 4,
wherein the pixel array region includes plural gate lines and plural drain lines intersecting each other, plural pixel electrodes arranged near each of intersections of the gate lines and the drain lines, and plural switching elements arranged near each of the plural pixel electrodes, and
wherein the group of lines for gate drivers is formed in a layer where the plural drain lines is formed, the first shield layer is formed in a layer where the plural gate lines are formed, and the second shield layer is formed in a layer where the plural pixel electrodes are formed.

11. The liquid crystal display device according to claim 9,
wherein using G-D conversion of gate lines, the gate lines in the edge region is formed in a layer where the plural drain lines are formed in the pixel array region.

12. The liquid crystal display device according to claim 1,
wherein the group of lines for gate drivers includes at least one of a negative power supply wiring and a common electrode wiring for the gate driver.

13. The liquid crystal display device according to claim 12,
wherein the data driver TAB member is connected to the edge region of the liquid crystal display panel, and
wherein the shield layer is connected to a specific power supply potential via the data driver TAB member.

14. The liquid crystal display device according to claim 13,
wherein the specific power supply potential is ground potential.
